(19) United States
(12) Patent Application Publication
(10) Pub. No.: US 2010/0180219 A1
(43) Pub. Date: Jul. 15, 2010

(54) Apparatus and method for providing user interface

(75) Inventors: Yun-sick Sung, Seoul (KR); Sung-won Ahn, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Gyeonggi-do (KR)

(21) Appl. No.: 12/654,683

(22) Filed: Dec. 29, 2009

(30) Foreign Application Priority Data
Jan. 15, 2009 (KR) 10-2009-0003428

(51) Int. Cl. G06F 3/01; G06F 3/041

(52) U.S. Cl. 715/762; 345/173

(57) ABSTRACT

Disclosed is a user interface (UI) providing technology to perform a complex function. According to an exemplary aspect, there is provided a complex UI which recognizes use patterns of a device based on user inputs and performs all of a plurality of functions at once according to the use pattern. Accordingly, various functions with high use frequency may be used through a simple manipulation.

### CROSS-REFERENCE TO RELATED APPLICATIONS

This application claims the benefit under 35 U.S.C. §119(a) of Korean Patent Application No. 10-2009-3428, filed on Jan. 15, 2009, the disclosure of which is incorporated by reference in its entirety for all purposes.

### BACKGROUND

1. Field

One or more embodiments relate to a user interface (UI) technology, and more particularly, to a graphic user interface (GUI) technology for controlling various functions of a device.

2. Description of the Related Art

A user interface (UI) is a physical or virtual medium which enables communication between a user and a system. Recently, with the development of input/output devices such as touch screens, graphic user interfaces have been advanced. For example, mobile phones with touch screens have been introduced, on the screen various icons are displayed to enable users to use various functions of the mobile phone through selections of the icons.

Execution of a certain function of a device is accompanied by several manipulations through a user interface. If a user wants to use a wake-up call function of a mobile phone, the user has to perform a series of processes of selecting a menu item to see a list of functions, selecting a wake-up call function from the list, inputting and storing a wake-up time on a displayed time input window, etc.

Moreover, as functions of devices become more and more complex, it becomes difficult for a user to find his or her desired function from among the many available functions of a device or the user is required to perform many manipulations to select a desired function.

In addition, since function buttons or icons on a conventional user interface have been set up in advance before the corresponding device is released in the market, such a user interface cannot match various user requirements, such as performing several functions at once.

Although there is a method of registering a specific function which is expected to be often used in a function execution interface such as “FavoritesMenu”, the method also requires additional manipulations for such registration and has limitation in matching a user's various requirements such as performing a plurality of functions at once.

Furthermore, when a plurality of functions, each accompanied by one or more manipulations, are repeatedly used in association with each other, inconvenience is further increased.

### SUMMARY

One or more embodiments relate to a technology of automatically providing a function-specific user interface according to a user's use pattern.

According to one or more embodiments, there is provided a user interface (UI) apparatus including an analysis unit to analyze a user input for controlling a device and obtain use pattern information associated with a plurality of functions of the device, and an UI creating unit to create a complex user interface to perform at least two functions of the plurality of functions of the device at once, based on the use pattern information.

According to one or more embodiments, there is provided a User Interface (UI) method including receiving a user input for controlling a device, analyzing the user input to obtain use pattern information associated with a plurality of functions of the device, and creating a complex user interface to perform at least two functions of the plurality of functions of the device at once, based on the use pattern information.

The at least two functions of the plurality of functions are functions that are used repeatedly in association with each other among functions of the device. Here, each function is a unitary or complex function of the device.

Also, the user input includes control commands for executing at least one function of the plurality of functions of the device. The use pattern information is obtained by statistically classifying and processing the control commands.

Also, the complex user interface may be provided as a graphic user interface on a touch screen, and include graphic data and a plurality of control commands for controlling the plurality of functions of the device.

Also, the complex user interface may be provided as a plurality of user complex interfaces corresponding to a plurality of complex functions of the device, and updated in real time according to the use pattern information.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 shows an exemplary device including the exemplary User Interface (UI);

FIG. 2 shows a case where the UI providing apparatus is a remote controller;

FIG. 3 is a block diagram illustrating the UI providing apparatus;

FIG. 4 is a view for explaining an operation of an exemplary complex user interface;

FIG. 5 is a view for explaining an operation of another exemplary complex user interface;

FIG. 6 illustrates an exemplary input/output unit; FIG. 7 illustrates an exemplary home network system; and

FIG. 8 is a flowchart illustrating an exemplary UI providing method.

### DETAILED DESCRIPTION OF EMBODIMENTS

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

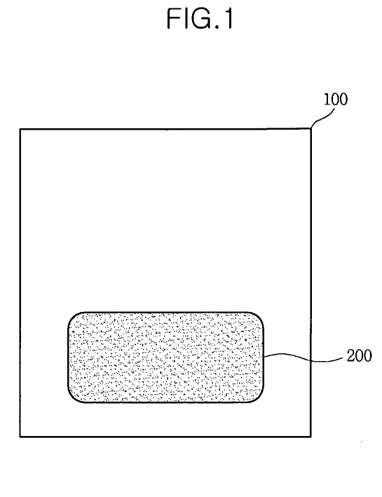

FIG. 1 shows an exemplary device 100 including an exemplary User Interface (UI) providing apparatus 200.

The device 100 may be an electronic device, such as a mobile phone, a PDA, a PMP, a TV, a refrigerator, a set-top box, and so on.

The UI providing apparatus 200 provides various buttons or graphic images to control the functions of the device 100. For example, the UI providing apparatus 200 may provide a graphic user interface (GUI) through a touch screen, such that a user touches graphic images displayed on the touch screen to utilize various functions of the device 100.

The functions of the device 100 may be classified into unitary functions and complex functions.

The term “unitary function” indicates a unitary operation of the device 100 that is executed by one control command. For example, if the device 100 is a mobile phone, in order for a user to utilize a wake-up call function, he or she has to press a menu button to see a list of available functions, select a wake-up call setting button from the list, then input a wake-up time to a displayed time input window and stores it. At this time, the operations of displaying the list of available functions, displaying the time input window, storing a wake-up time, and causing a bell to ring at the stored time may each be referred to as unitary functions.

The complex function means a combination of two or more unitary or complex functions. For example, the wake-up call function into which the operations of displaying the list of functions, displaying the time input window, storing a wake-up time, and causing the bell to ring at the stored time are combined may be a complex function. Also, the complex function may be a combination of two or more complex functions, such as setting a wake-up call and calling a designated person.

In FIG. 1, the UI providing apparatus 200 may analyze user inputs, create a user interface allowing a function to be performed through one manipulation, i.e., without requiring many manipulations to be carried out, according to the results of the analysis, and provide the user interface to the user.

In the case of a mobile phone, setting a wake-up call accompanies several manipulations including selecting a menu button, selecting a wake-up call setting function, inputting a wake-up time, and so on. However, according to the current example, the UI providing apparatus 200 analyzes user inputs, recognizes repeated settings of a wake-up call at a specific time, and provides the user with a function execution button or graphic image for setting a wake-up call at the specific time. Accordingly, the user may easily use the wake-up call setting function through one manipulation of the function execution button or graphic image.

As another example, there is the case where a user calls a certain person after setting a wake-up call. In this case, the user has to perform manipulations of inputting a phone number of the person, pressing a ‘call’ button, etc., after setting the wake-up call described above. The UI providing apparatus 200 determines that a wake-up call function is repeatedly used in association with a function of calling a designated person, and provides the user with a function execution button or graphic image for performing both of the functions at once.

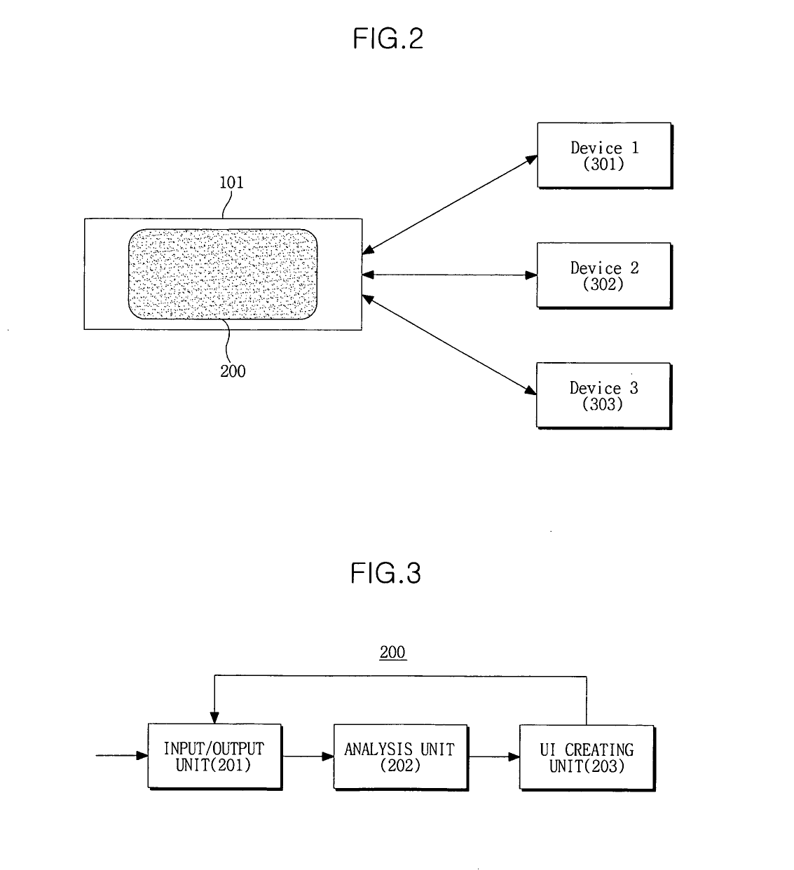

FIG. 2 shows a case where the UI providing apparatus 200 is installed in a remote controller 101.

The remote controller 101 may be a general remote control, a set-top box, a mobile phone, etc., which can remotely control external devices 301, 302, and 303. Here, the remote control may be performed in a wired or wireless fashion. An example of the case where the remote control is performed in a wired fashion may be the case where the remote controller 101 is connected with the external devices 301, 302, and 303 via a home network. Also, the external devices 301, 302, and 303 that are controlled by the remote controller 101 may be home appliances, such as a TV, a humidifier, a refrigerator, etc., which are connected to a home network.

The UI providing apparatus 200, as described above with reference to FIG. 1, may analyze user inputs, create a user interface for allowing a function to be performed through one manipulation, without having to perform many manipulations, and provide a user with the user interface.

For example, if a user has repeatedly performed the operation of turning on a humidifier (for example, device 302) while watching a TV (for example, device 301), the UI providing apparatus 200 may create and display a predetermined image and allow the user to select the image to turn on the TV 301 and humidifier 302 simultaneously.

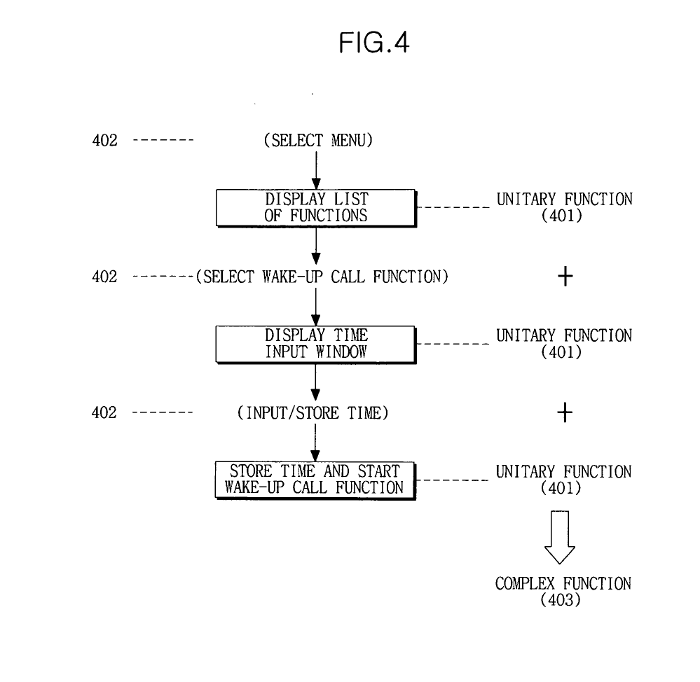

FIG. 3 is a block diagram illustrating the UI providing apparatus 200.

Referring to FIG. 3, the UI providing apparatus 200 includes an input/output unit 201, an analysis unit 202, and a UI creating unit 203.

The input/output unit 201 receives user inputs to control a device. For example, the input/output unit 201 may be a touch screen to receive user inputs and display the status of a device according to the user inputs.

The device may be an apparatus (for example, a mobile phone) in which the UI providing apparatus 200 is installed, or an apparatus (for example, a TV, a refrigerator, etc.) that is controlled remotely by the apparatus in which the UI providing apparatus 200 is installed (see FIGS. 1 and 2).

The user inputs include various control commands for controlling the device. For example, if the input/output unit 201 is a touch screen, the user selects a graphic image displayed on the input/output unit 201 and the input/output unit 201 outputs a control command corresponding to the selected graphic image.

The analysis unit 202 analyzes the user inputs and obtains use pattern information based on the results of the analysis. For example, the analysis unit 202 analyzes a user input and the status of the input/output unit 201 when the user input occurs, classifies and stores the user input based on the results of the analysis, and obtains use pattern information according to the stored user input. Here, the user input may be a control command for executing a unitary function or a complex function.

Also, the use pattern information may be the user's trends associated with functions of a device. For example, information about functions that are repeatedly and frequently used or that are successively used in association with each other, among a plurality of functions of the device, may be use pattern information. As in the above-described examples, “a user tends to set a wake-up call to ring at 7 a.m.”, “a user tends to call a person A after setting a wake-up call to ring at 7 a.m.” or “a user tends to turn on a TV and a humidifier together” may represent use pattern information.

The UI creating unit 203 creates a complex user interface to perform the plurality of functions of the device at once, based on the use pattern information. The complex user interface may be displayed as a graphic image corresponding to a command to perform the plurality of functions of the device at once. For example, the UI creating unit 203 may create a predetermined graphic image and control commands and provide them to the input/output unit 201. Here, the term “create” includes a process of selecting a graphic image suitable for a specific complex function from among stored various graphic images or combining control commands corresponding to respective functions.

The control commands may be a combination of control commands corresponding to respective unitary functions or complex functions. For example, if the use pattern information corresponds to “a user tends to call a person A after setting a wake-up call to ring at 7 a.m.”, control commands, such as “(command of setting a wake-up call)+(command of inputting a time of 7 a.m.)+(command of inputting a phone address of a person A)+(command of calling)”, may be created.

Accordingly, when the user selects the graphic image created by the UI creating unit 203, the operation of setting a wake-up call at 7 a.m. and then calling person A may be performed automatically.

Also, the use pattern information and complex user interface may be stored separately. Also, the complex user interface may be provided as a plurality of complex user interfaces corresponding to complex functions of the device, and may be updated in real time according to the use pattern information.

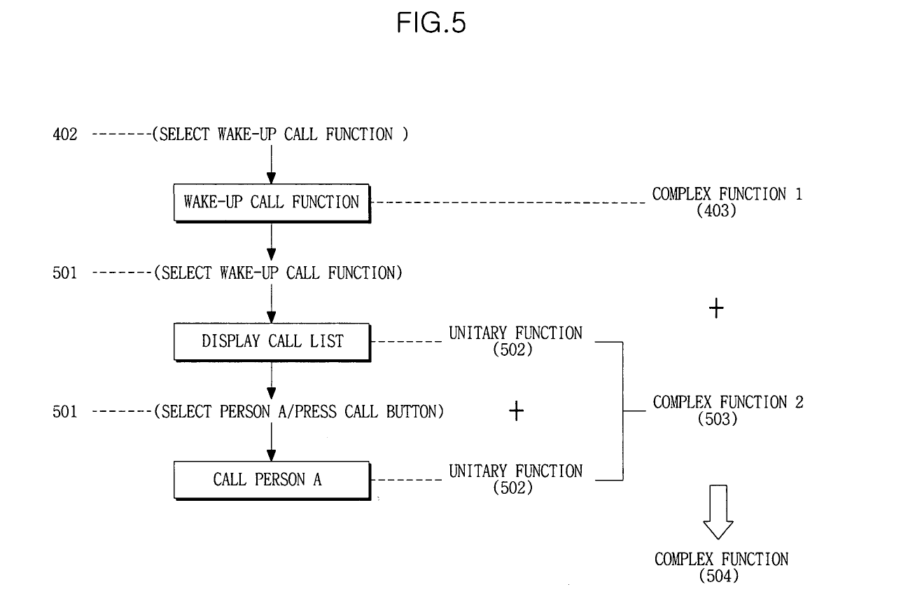

Now, the complex user interface will be described in more detail with reference to FIG. 4, below.

In FIG. 4, a reference number 401 represents a unitary function, a reference number 402 represents a user input, and a reference number 403 represents a complex function.

For example, if the UI providing apparatus 200 (see FIG. 3) is installed in a mobile phone, the complex function 403 may be a wake-up call setting function. In order to set a wake-up call, as illustrated in FIG. 4, many manipulations, such as selecting a menu, selecting a wake-up call function, inputting/storing a time, etc., are needed. Also, unitary functions, such as outputting a list of functions, outputting a time input window, storing an input time, starting a wake-up call function, etc., are performed in response to respective user inputs.

Referring to FIGS. 3 and 4, if the user has repeatedly used a wake-up call function in which a wake-up time is set to 7 a.m., the analysis unit 202 included in the UI providing apparatus 200 analyzes user inputs and obtains use pattern information associated with the wake-up call function based on the results of the analysis. The use pattern information is input to the UI creating unit 203, and the UI creating unit 203 creates a complex user interface including image data corresponding to a complex function 403 and control commands, based on the use pattern information.

The complex user interface may be provided in the form of a graphic user interface (GUI) to the user. If the user selects the corresponding image, processes including selecting a menu, selecting a wake-up call function, inputting/storing a wake-up time, etc., are performed at once according to the control commands. Accordingly, processes of selecting a desired function from among a list of functions and inputting a time are no longer needed, so that the user can use a wake-up call function conveniently.

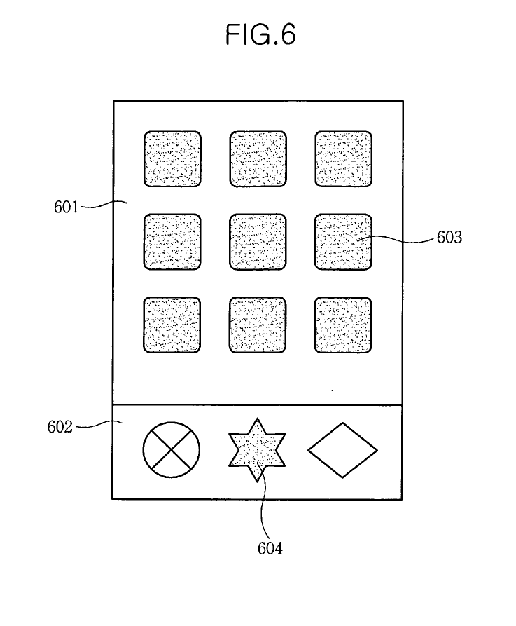

Hereinafter, another exemplary complex user interface will be described with reference to FIG. 5.

In FIG. 5, a reference number 402 represents a user input associated with the wake-up call function described above with reference to FIG. 4 and a reference number 403 represents the complex function described above with reference to FIG. 4. Also, a reference number 501 represents a user input for calling a person A, a reference number 502 represents a unitary function that is performed when calling person A, and a reference number 503 represents a complex function associated with a call function.

For example, if the UI providing apparatus 200 is installed in a mobile phone, a complex function 504 may be a combination of a wake-up call function (that is, complex function 403) and a function of calling person A (that is, complex function 503).

If the user tends to use a wake-up call function in which a wake-up time is set to 7 a.m. in association with a function of calling person A, the analysis unit 202 of the UI providing apparatus 200 analyzes user inputs and obtains use pattern information associated with the wake-up call function and the call function based on the results of the analysis. The use pattern information is input to the UI creating unit 203, and the UI creating unit 203 creates a complex user interface including image data corresponding to the complex function 504 and control commands, based on the use pattern information.

The complex user interface may be provided in the form of a GUI to the user. When the user selects the corresponding image, processes including selecting a menu, selecting a wake-up call function, inputting/storing a wake-up time, selecting a person A, calling person A, etc., are performed at once according to the control commands. In other words, functions that have been repeatedly used in associated with each other are all performed at once through one manipulation.

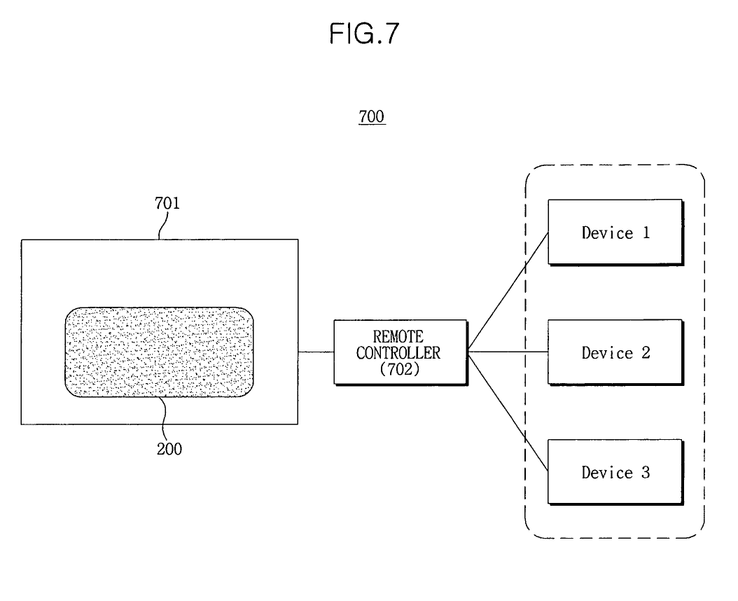

FIG. 6 illustrates an example of the input/output unit 201.

Referring to FIG. 6, the input/output unit 201 may be a touch screen and include a unitary function UI display unit 601 and a complex function UI display unit 602.

The unitary UI display unit 601 displays icons (for example, icon 603) for executing unitary functions. When a user selects the icon 603, a unitary function, such as displaying a list of functions, displaying a time input window, etc., is performed.

The complex function UI display unit 602 displays icons (for example, icon 604) for executing complex functions (for example, icon 604). When a user selects the icon 604, a plurality of functions are all performed at once. For example, when the user selects a complex function icon 604, a wake-up call function of setting a wake-up call automatically at a specific time and a function of calling a designated person at the specific time may both be performed at the same time.

As described above, the complex function UI display unit 602 may display a plurality of icons 604 corresponding to complex functions, and may be updated in real time according to the use information pattern.

FIG. 7 illustrates an exemplary home network system 700.

Referring to FIG. 7, the home network system 700 includes a server 701, a remote controller 702, and a plurality of devices 703.

The remote controller 702 may be a central network apparatus to remotely control the plurality of devices 703 in a wired or wireless fashion. For example, the plurality of devices 703 may be electronic appliances 703 which can be controlled by a mobile phone 702.

The server 701 receives a user input from the remote controller 702, and performs processing of various pieces of information. Here, the server 701 may include the UI providing apparatus 200 described above with reference to FIG. 3. For example, the server 701 analyzes a user input received from the remote controller 702, obtains use pattern information associated with functions of the device 703, and provides the remote controller 702 with a complex UI based on the use pattern information.

Conventionally, if the user wanted to use a specific function a of the device 1 in association with a specific function b of the device 2, the user had to select the device 1 through the remote controller 702, select the function a from among a list of functions of the device 1, then select the device 2, and select the function b from a list of functions of the device 2. However, according to the current example, if the functions a and b are repeatedly used, the UI providing apparatus 200 of the server 701 obtains use pattern information indicating that the function a of the device 1 is used in association with the function b of the device 2, creates a complex UI for allowing the function a of the device 1 and the function b of the device 2 to be performed at once, and provides the complex UI to the remote controller 702.

For example, if a user tends to turn off a TV and switch a humidifier to a silent mode every evening, a complex UI for the commands to “turn off a TV and switch a humidifier to a silent mode” may be created and displayed on the remote controller 702.

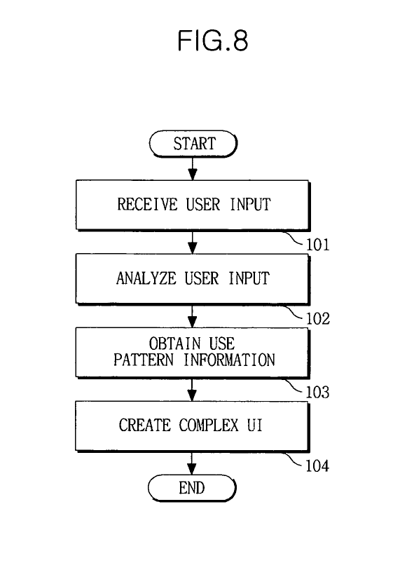

FIG. 8 is a flowchart illustrating an exemplary UI providing method. Below, references will be made to FIGS. 3 and 8, for example. However, embodiments with the below referenced processes are not limited to any particular configuration or device discussed above, such that the below discussion is merely for ease of discussion, and not intended to be limiting of embodiments of the present invention.

Accordingly, referring to FIGS. 3 and 8, the input/output unit 201 receives a user input to control a device (operation 101). Here, the user input includes a control command associated with a unitary function or a complex function of the device.

Successively, the analysis unit 202 analyzes the user input (operation 102). For example, the analysis unit 202 may classify and store user inputs by statistically analyzing what functions have high frequency of use, what functions are used successively within a predetermined time interval, etc. An exemplary analysis method may be analysis through Bayesian Statistics.

Then, the analysis unit 202 obtains use pattern information based on the results of the analysis (operation 103). The use pattern information may be information about frequency of use for each function, information about functions repeatedly used in association with each other, etc.

Then, the UI creating unit 203 creates a complex UI to perform a plurality of functions at once using the use pattern information (operation 104). For example, the complex UI may include unitary functions constructing a complex function, a group of control commands corresponding to the complex function, and specific image data.

The complex UI is provided to the input/output unit 201 and displayed for the user, so that the user selects the complex UI to perform a plurality of functions all at once.

Also, alternatively, the UI providing method illustrated in FIG. 8 is performed whenever a user input occurs, so that the complex UI can be updated in real time. Also, it is possible that when a user input occurs, a plurality of complex UIs are created.

As described above, according to the current example, since a plurality of functions that are often used by a user are integrated and performed automatically, the number of manipulations required for controlling a device may be reduced.

In addition to the above described embodiments, embodiments can also be implemented through computer readable code/instructions in/on a medium, e.g., a computer readable medium, to control at least one processing device to implement any above described embodiment. The medium can correspond to any defined, measurable, and tangible structure permitting the storing and/or transmission of the computer readable code.

The media may also include, e.g., in combination with the computer readable code, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of computer readable code include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A user interface (UI) apparatus comprising:
an analysis unit to analyze a user input for controlling a device and obtain use pattern information associated with a plurality of functions of the device; and
an UI creating unit to create a complex user interface to perform at least two functions of the plurality of functions of the device at once, based on the use pattern information.

2. The UI apparatus of claim 1, wherein the at least two functions of the plurality of functions are functions that are used repeatedly in association with each other among functions of the device.

3. The UI apparatus of claim 1, wherein the user input includes control commands for executing at least one function of the plurality of functions of the device.

4. The UI apparatus of claim 3, wherein the analysis unit obtains the use pattern information by statistically classifying and processing the control commands.

5. The UI apparatus of claim 1, wherein the complex user interface is provided as a graphic user interface on a touch screen.

6. The UI apparatus of claim 1, wherein the complex user interface includes image data and control commands for executing the at least two functions of the plurality of functions of the device.

7. The UI apparatus of claim 1, wherein the complex user interface is provided as a plurality of complex user interfaces corresponding to a plurality of complex functions of the device.

8. The UI apparatus of claim 1, wherein the complex user interface is updated in real time according to the use pattern information.

9. The UI apparatus of claim 1, wherein the device includes an apparatus in which the UI providing apparatus is installed, or an apparatus which is remote-controlled by the apparatus in which the UI providing apparatus is installed.

10. A User Interface (UI) method comprising:
receiving a user input for controlling a device;
analyzing the user input to obtain use pattern information associated with a plurality of functions of the device; and
creating a complex user interface to perform at least two functions of the plurality of functions of the device at once, based on the use pattern information.

11. The UI method of claim 10, wherein the at least two functions of the plurality of functions are functions that are used repeatedly in association with each other among functions of the device.

12. The UI method of claim 10, wherein the user input includes control commands for executing at least one function of the plurality of functions of the device.

13. The UI method of claim 12, wherein the obtaining of the use pattern information comprises statistically classifying and processing the control commands.

14. The UI method of claim 10, wherein the complex user interface is provided as a graphic user interface on a touch screen.

15. The UI method of claim 10, wherein the complex user interface includes image data and control commands for executing the at least two functions of the plurality of functions of the device.

16. The UI method of claim 10, wherein the complex user interface is a plurality of complex user interfaces corresponding to a plurality of complex functions of the device.

17. The UI method of claim 10, wherein the complex user interface is updated in real time according to the use pattern information.
